(19) United States
(12) Patent Application Publication
(10) Pub. No.: US 2008/0291684 A1
(43) Pub. Date: Nov. 27, 2008

(54) PILLOW READING LAMP

(76) Inventor: Michele A. Egan, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 11/752,738

(22) Filed: May 23, 2007

(51) Int. Cl. F21V 21/00; F21V 15/01

(52) U.S. Cl. 362/374; 362/362; 362/382

(57) ABSTRACT

A reading lamp includes a lamp assembly. The lamp assembly includes a housing has a first aspect and a second aspect in opposed relation to the first aspect. A lamp is situated substantially at the first aspect. The lamp is configured to cast illumination away from the first and second aspects in response to application of a current between a first and second terminal. A cushion is configured to support the housing substantially at the second aspect.

### FIELD OF THE INVENTION

This invention relates generally to light technology and, more specifically, to book light technology.

### BACKGROUND OF THE INVENTION

Since Victorian times, when gas lamps or candles were positioned in sconces flanking beds, the act of reading in bed has been supported by hardware innovation. Apart from lamps affixed to walls or resting on nightstands, a separate genre of hardware, known as “book light” has emerged and generally encompasses small lamps positioned by the user to illuminate either of a book or magazine or some work piece such as embroidery where detailed examination of the work is necessary.

The most frequent embodiment of the book light is an apparatus that can be supported by an object to be illuminated (e.g., a book) in various ways. For example, a portable book light is taught in U.S. Pat. Nos. 4,432,042 and Des. 271,526. That book light includes a base supporting a vertical lamp-bearing arm and in integral clamp consisting of a U-shaped frame having side arms rigidly attached to the base. A central plate is flexibly attached to the base so that the entire book light may be attached to a book or other publication by inserting the cover or pages between the arms and the central plate.

A similar book light is described in U.S. Pat. No. 5,180,220 and relates to a stitchery light-base and clamp. The stitchery light includes an arm for supporting a lamp and a base member for supporting the arm on a stitchery implement. The base member includes a clamping member arranged to adjustably mount on a stitchery implement.

A second means of fixation relies upon the pages of the book as is taught in U.S. Pat. No. 5,442,528. The device is a lighted bookmark which can be placed between the pages of a book and functions as a portable book light while reading. A light-bearing neck of the bookmark can be retracted to fit within the body of the bookmark and can be extended out of the bookmark, causing the light to automatically energize. The neck possesses a memory effect that returns the neck to its original curved position when extended.

Each of these examples requires fixation to the book or work and by doing so, places the weight of the lamp to burden the user's grasp and tends to extend the center of gravity outward making the grasp of the book or work less wieldy. What is needed in the art, is a book light that does not depend from the book or work for support and yet lends an even and ample illumination of the book or work.

### SUMMARY OF THE INVENTION

A reading lamp includes a lamp assembly. The lamp assembly includes a housing has a first aspect and a second aspect in opposed relation to the first aspect. A lamp is situated substantially at the first aspect. The lamp is configured to cast illumination away from the first and second aspects in response to application of a current between a first and second terminal. A cushion is configured to support the housing substantially at the second aspect.

### BRIEF DESCRIPTION OF THE DRAWINGS

Preferred and alternative embodiments of the present invention are described in detail below with reference to the following drawings:

FIG. 1 is a reading lamp in use;

FIG. 2 is an exploded diagram of the reading lamp;

FIG. 3 is cross-section diagram of the reading lamp; and

FIG. 4 is a perspective diagram of a second embodiment of the reading lamp.

### DETAILED DESCRIPTION OF THE PREFERRED EMBODIMENT

A reading lamp includes a lamp assembly. The lamp assembly includes a housing has a first aspect and a second aspect in opposed relation to the first aspect. A lamp is situated substantially at the first aspect. The lamp is configured to cast illumination away from the first and second aspects in response to application of a current between a first and second terminal. A cushion is configured to support the housing substantially at the second aspect.

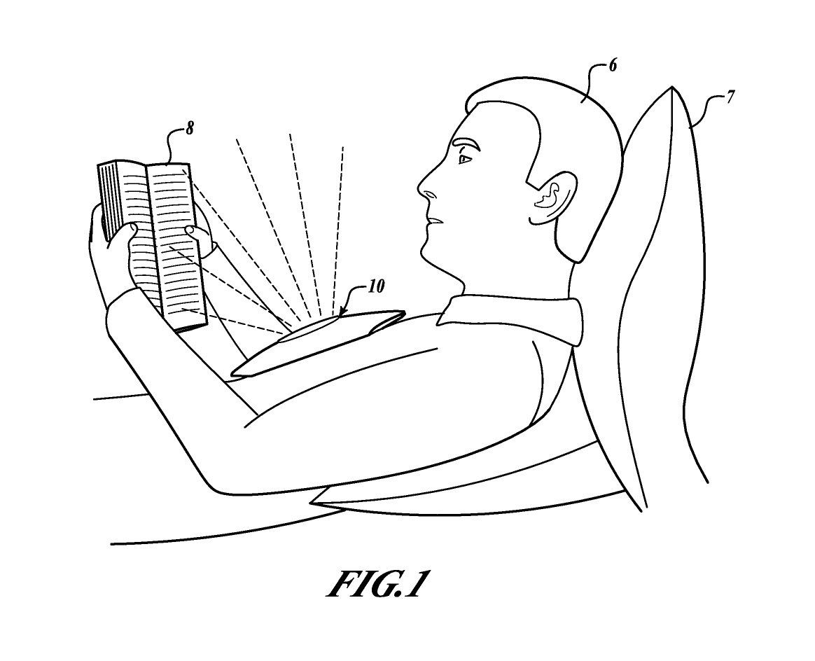

Referring to FIG. 1, a user 6, propped on a number of cushions 7 is reading a book. The user 6 has illuminated the book 8 using the reading lamp 10. The reading lamp 10 is positioned to best illuminate the book 8 and does so without creating the more localized illumination that frequently occurs with book lights that depend from the book 8 itself. Because the reading lamp 10 can be positioned on the user 6 at a distance from the book 8 that assures more even illumination and yet allows the illumination at angles that are not nearly normal to the surface of the book 8 thereby causing glare.

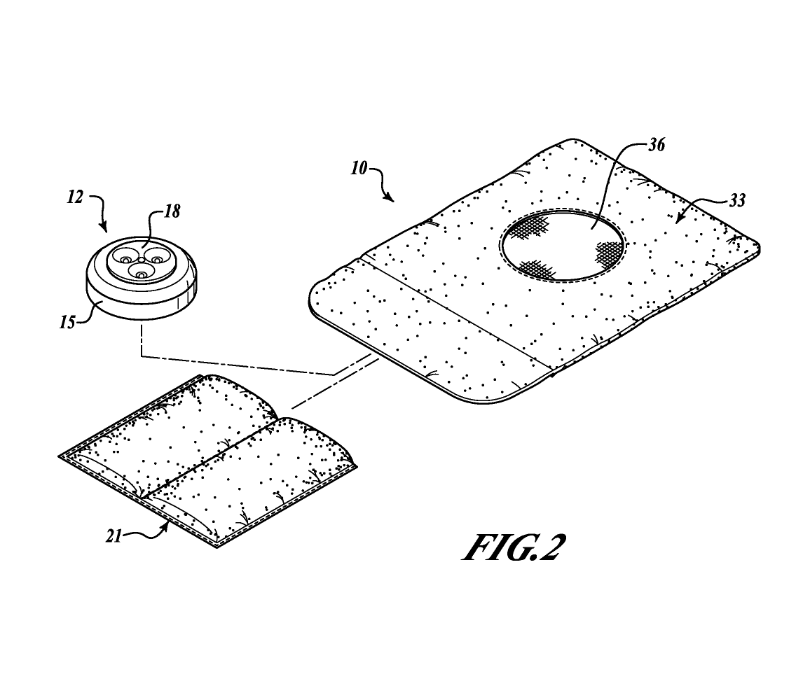

Referring to FIG. 2, a non-limiting embodiment of the reading lamp 10 may include a lamp assembly 12 having at least one lamp 18 mounted in a housing 15. In one embodiment, the Sylvania™ DOT it™ product suitably serves as the lamp assembly 12.

The lamp assembly 12 includes the housing 15 holds the at least one lamp 18 at a first aspect of the housing 15. In a non-limiting embodiment, the housing 15 includes a power source, a switch, and suitable circuitry pass a current through the lamp 18, causing the lamp 18 to illuminate and thereby to cast an illumination emanating away from the housing.

In the preferred embodiment the lamp 18 is a light emitting diode (LED). An LED is a semiconductor device that emits incoherent narrow-spectrum light when electrically biased in the forward direction of the p-n junction. This effect is a form of electroluminescence. An LED is a small extended source with extra optics added to the chip that makes an LED to emit a complex radiation pattern [1]. The color of the emitted light depends on the composition and condition of the semiconducting material used, and can be infrared, visible or near-ultraviolet. If the emitting layer material of an LED is an organic compound, it is known as an Organic Light Emitting Diode (OLED). To function as a semiconductor, the organic emitting material must have conjugated pi bonds. The emitting material can be a small organic molecule in a crystalline phase, or a polymer. Polymer materials can be flexible; such LEDs are known as PLEDs or FLEDs.

One of the key advantages of LED-based lighting is its high efficiency, as measured by its light output per unit power input. White LEDs quickly matched and overtook the efficiency of standard lighting systems. In 2002, Lumileds made 5-watt LEDs available with efficacy of 18-22 lumens per watt. For comparison, a conventional 60-100 watt incandescent lightbulb produces around 15 lumens per watt. The salient feature of this efficiency in producing light is the absence of any significant heat that might burn skin or cause combustion. LEDs are presently preferred for the lamp 18 because of the lack of heat and the long life this efficiency imparts to the power source.

A second element of the reading lamp 10 is the cushion 21 which serves as a base to the lamp assembly 12 in use. In one non-limiting embodiment, the cushion 21 is a bean bag, a small cloth bag filled with dried beans, as might be used for tossing in various children's games. Advantageously, such a cushion 21 will conform to irregular surfaces and will ballast the reading lamp 10 making the reading lamp 10 stable in use, such as is illustrated in FIG. 1.

The cushion 21 is configured having filling elements situated within an envelope 24 made of pliable, generally planar material. Filling elements might be either solid particles or even liquid. Viscous liquids such as a gel (a colloidal system in which a porous network of interconnected nanoparticles spans the volume of a liquid medium) may also admirably serve. A cushion 21 having the quality of being plastically formable is well-suited for the reading lamp 10.

A third element of the reading lamp is the sheath 33. In one non-limiting embodiment, the sheath 33 includes a translucent window 36 configured to allow light to pass through sheath 33 from the lamp assembly 12 outward. The sheath 33 provides a mechanical connection between the lamp assembly 12 and the cushion 21.

In the pictured embodiment, the sheath 33 is configured to envelop the cushion 21 and the lamp assembly 12. In alternate embodiments, the sheath 33 could be configured to envelope the cushion 21 and to fasten to the lamp assembly 12 at a second aspect, away from the lamp 18. In another alternate embodiment, the sheath 33 is a mechanical connection between the lamp assembly 12 and the cushion 21. By way of non-limiting example, the sheath 33 is a double-sided adhesive planar sheet that secures the lamp assembly 12 to the cushion 21. As used herein, the sheath 33 is any mechanical connection between the lamp assembly 12 and the cushion 21.

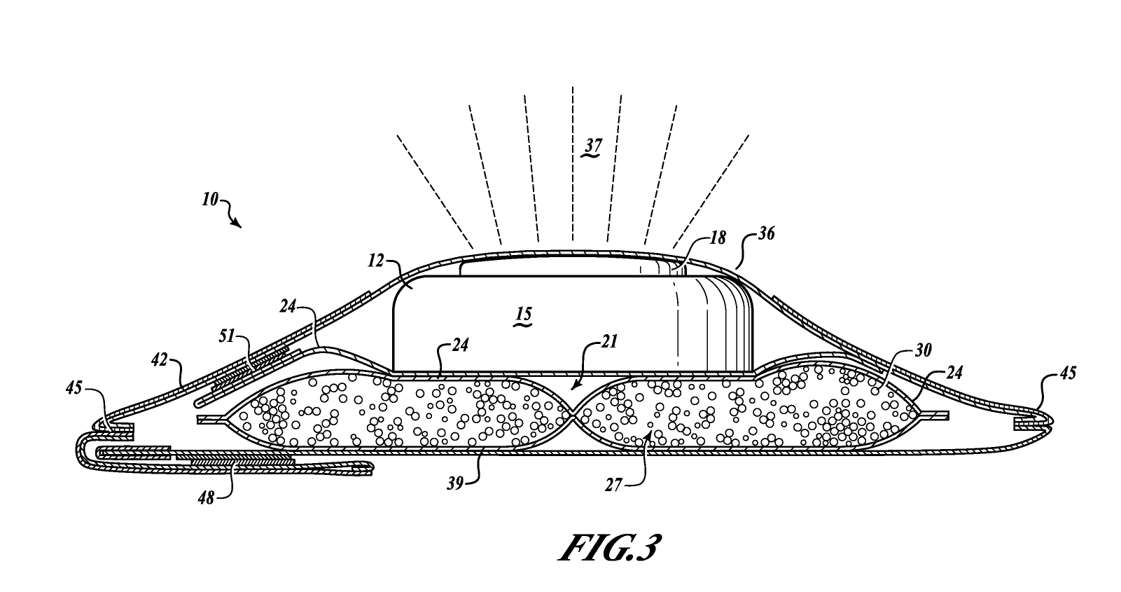

A cross-sectional view of the reading lamp 10 is shown in FIG. 3. The lamp assembly 12, having the housing 15 and the lamp 18 on a first aspect, rests upon the cushion 21. The cushion 21 includes the envelope 24 filled with filling elements 27. In this non-limiting embodiment, the filling element comprises solid particles 30 that move freely over and around each other. Much as dry beans in a bean bag, the solid particles are bound by the envelope 24 causing the whole group of solid particles within the envelope to have the quality of being plastically formable, allowing the cushion 21 to conform at the surface of the envelope 24 to generally irregular surfaces.

Solid partiles may include any or any combination of free flowing solid particles selected from a group consisting of resinous filaments, beads, beans, grain, grain husks, sand, and shot. Each of these has been traditionally used for similar sorts of cushions, for example, a sand bag. By way of another example, buckwheat hulls are used as filling for a variety of upholstered goods, including pillows and zafu. The hulls are durable and do not conduct or reflect heat as much as synthetic fills.

In one embodiment, the cushion may also include aromatic oils suitable for aromatherapy. Aromatherapy is the use of volatile liquid plant materials, known as essential oils (EOs), and other scented compounds from plants for the purpose of affecting a person's mood or health. Aromatherapy is a generic term that refers to any of the various traditions that make use of essential oils sometimes in combination with other alternative medical practices and spiritual beliefs. It has a particularly Western currency and persuasion. In practice, addition of suitable oils to the cushion may have a soothing effect upon the reader. In the case of children or infirm users, the cushion becomes a convenient reservoir for such oils.

Viscous liquids or gels may also serve as a suitable filling element 27. Gels such as those commonly used for mouse pads and as inserts in bicycle gloves and saddles would be suitably plastically formable to serve as filling elements 27 to the cushion 21.

The lamp assembly 12 and cushion 21 are enveloped in the sheath 33. The window 36 is situated in the sheath 33 to allow illumination 37 to escape the sheath 33 from the lamp 18. In this non-limiting example, the window 36 is a translucent panel in a cover layer 42 of the sheath 33.

The sheath 33 includes the cover layer 42 attached to a base layer 39 attached to one another by a seal 45 to form a wrapper. The seal 45 may be either continuous or discontinuous and need not be homogenous. In one non-limiting example, the seal 45 includes a first fastener 48 that prevents the cushion 21 from leaving the sheath 33. One non-limiting example of such a first fastener 48 is a corresponding pair of hook and loop fasteners.

Hook and loop fasteners consist of two layers: a “hook” side, which is a piece of fabric covered with tiny plastic hooks, and a “loop” side, which is covered with even smaller and “hairier” plastic loops. There are many variations to this which include hooks on both sides, for example. When the two sides are pressed together, the hooks catch in the loops and hold the pieces together. When the layers are separated, the strips make a characteristic ripping sound. A variant is the hook and eye, generally a metal single hook attached to a first planar material that engages a single loop attached to a second planar material.

Another non-limiting example of a suitable first fastener 48 is a zipper. The bulk of a zipper consists of two strips of fabric tape, each affixed to one of the two pieces to be joined, carrying tens or hundreds of specially shaped metal or plastic teeth. A slider, operated by hand, moves along the rows of teeth. Inside the slider is a Y-shaped channel that meshes together or separates the teeth when situated in opposed relationship, depending on the direction of its movement.

Still another example of a suitable first fastener 48 is a snap fastener. The snap fastener (also called snap, popper, and press stud) is a pair of interlocking discs commonly used in place of buttons to fasten clothing. Snaps can be attached to material by hammering, plying, or sewing. For plying snap fasteners, there are special snap pliers.

Still another suitable first fastener 48 is a buckle. A buckle (from Latin buccula) is a clasp used for fastening two things together, such as the ends of a belt, or for retaining the end of a strap. Before the invention of the zipper, buckles were commonly used to fasten clothing.

Buttons may also serve as the first fastener 48. The button is a small disc- or knob-shaped, typically round, object usually attached to an article of clothing in order to secure an opening, or for ornamentation. Functional buttons work by slipping the button through a fabric or thread loop, or by sliding the button through a slit called a buttonhole.

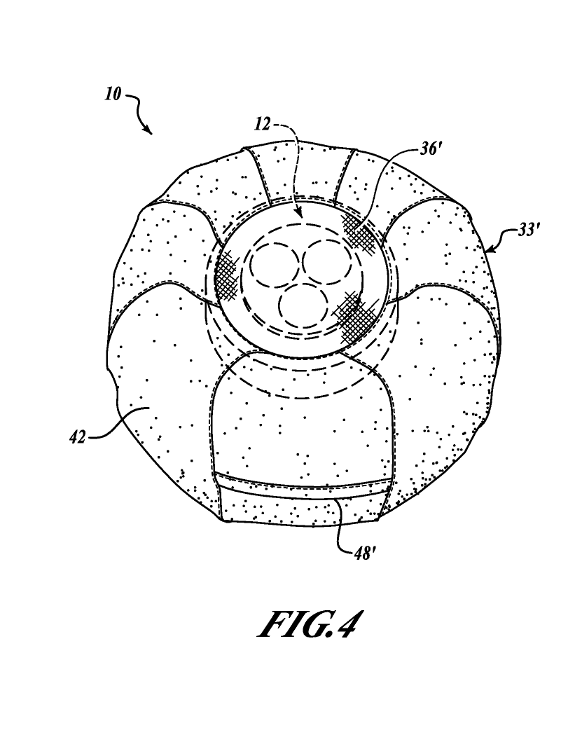

Referring to FIG. 4, an alternate embodiment of the reading lamp 10 is shown. The sheath 33′ is generally planar but round within the plane. Rather than a single sheet, the top layer 42 is made up of a number of crescent-shaped sheets much as a beach ball is made up of crescent-shaped panels. A round window 36′ is configured to transmit illumination from the lamp assembly 12 (shown in phantom).

While the preferred embodiment of the invention has been illustrated and described, as noted above, many changes can be made without departing from the spirit and scope of the invention. For example, as demonstrated in the alternate embodiment, the shape of the lamp may be varied for decorative or functional reasons. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A reading lamp comprising:
a lamp assembly including:
a housing having a first aspect and a second aspect in opposed relation to the first aspect;
a lamp situated substantially at the first aspect, the lamp being configured to cast illumination away from the first and second aspects in response to application of a current between a first and second terminal;
a cushion configured to support the housing substantially at the second aspect.

2. The reading lamp of claim 1, wherein the cushion includes:
a pliable envelope defining and enclosing a cavity; and
at least one plastically formable filling element substantially filing the cavity.

3. The reading lamp of claim 2, wherein the plastically formable filling element includes a plurality of free flowing solid particles selected from a group consisting of resinous filaments, beads, beans, grain, grain husks, sand, and shot.

4. The reading lamp of claim 2, the plastically formable filling element are selected from a group consisting of gel, liquid, gas, and air.

5. The reading lamp of claim 1, further comprises:
a sheath a configured to envelop the lamp assembly and the cushion and having a window configured to communicate the illumination through the sheath.

6. The reading lamp of claim 5, wherein the sheath includes:
a planar material including:
a base layer;
a cover layer applied to the base layer; and
a continuous or discontinuous seal therebetween.

7. The reading lamp of claim 6, wherein the continuous or discontinuous seal includes one of a group consisting of a button, at least one male and female corresponding pair of hook and loop fastener elements, at least one male and female corresponding pair of hook and eye fastener elements; a zipper; a buckle; at least one male and female corresponding pair of hasp elements, and at least one male and female corresponding pair of snap elements.

8. The reading lamp of claim 1, wherein the cushion further includes one of a group consisting of essential oils, absolutes, volatile organic compounds, herbal distillates, and infusions.

9. A wrapper for a lamp assembly comprising:
a cushion configured to support the lamp assembly; and
a sheath a configured to envelop the light assembly and the cushion and having a window configured to communicate the illumination through the sheath.

10. The wrapper of claim 9, wherein the sheath includes:
a planar material including:
a base layer;
a cover layer applied to the base layer; and
a continuous or discontinuous seal therebetween.

11. The wrapper of claim 10, wherein the continuous or discontinuous seal includes one of a group consisting of at least one button, at least one male and female corresponding pair of hook and loop fastener elements, at least one male and female corresponding pair of hook and eye fastener elements; a zipper; a buckle; at least one male and female corresponding pair of hasp elements, and at least one male and female corresponding pair of snap elements.

12. The wrapper of claim 9, wherein the cushion further includes one of a group consisting of essential oils, absolutes, volatile organic compounds, herbal distillates, and infusions.

13. The wrapper of claim 9, wherein the cushion includes:
a pliable envelope defining and enclosing a cavity; and
at least one plastically formable filling element substantially filing the cavity.

14. The wrapper of claim 13, wherein the plastically formable filling element includes a plurality of free flowing solid particles selected from a group consisting of resinous filaments, beads, beans, grain, grain husks, sand, and shot.

15. The wrapper of claim 9, wherein the plastically formable filling element are selected from a group consisting of gel, liquid, gas, and air.

16. A device for supporting a lamp assembly, the device comprising:
a cushion for supporting the lamp assembly, the cushion has a top side and a bottom side and comprises a pliable material;
a fluid material contained within the cushion, the fluid material comprises free flowing solid particles to provide adequate support and ballast while being highly pliable; and
a wrapper configured to mechanically link the lamp assembly to the cushion.

17. The device of claim 16, wherein the top side and the bottom side comprise a single piece of pliable material folded in half and sewn on three sides to contain the fluid material.

18. The device of claim 16, wherein the bottom of the cushion consists of a skid resistant material.

19. The device of claim 16, wherein the wrapper envelops the cushion.

20. The device of claim 16, wherein the wrapper envelops the lamp assembly and includes a translucent window configured to transmit illumination from the lamp assembly through the wrapper.
